(19) United States
(12) Patent Application Publication
(10) Pub. No.: US 2009/0157223 A1
(43) Pub. Date: Jun. 18, 2009

(54) ROBOT CHATTING SYSTEM AND METHOD

(75) Inventors: Joong-Ki PARK, Daejeon (KR); Byung Ho Chung, Daejeon (KR); Hyun Sook Cho, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/209,628

(22) Filed: Sep. 12, 2008

(30) Foreign Application Priority Data
Dec. 17, 2007 (KR) 10-2007-0132689

(51) Int. Cl. G05B 19/04

(52) U.S. Cl. 700/246; 901/50

(57) ABSTRACT

A robot chatting system includes an interface for generating a chatting text including robot motion having a text part and a motion part; a robot chatting server for providing a robot chatting service between chatting persons, using the chatting text including robot motion; a first unit for generating motion control data corresponding to the motion part of the chatting text including robot motion; a second unit for converting the text part of the chatting text including robot motion into speech data; and a robot for outputting the speech data through a speaker and simultaneously motioning based on the motion control data. Therefore, when the user inputs text and its corresponding motions and sends the input text, the other user's robot reads the text and performs the relevant motions, thereby providing the robot chatting service of good quality.

### CROSS-REFERENCE(S) TO RELATED APPLICATIONS

The present invention claims priority of Korean Patent Application No. 10-2007-0132689, filed on Dec. 17, 2007, which is incorporated herein by reference.

### FIELD OF THE INVENTION

The present invention relates to robot chatting, and more particularly, to a robot chatting system and method in which, when a user inputs a text to be sent and its corresponding motions and sends the input text, another user's robot reads the text and performs the motions.

### BACKGROUND OF THE INVENTION

In the future, robots will be supplied to be variously used in homes and offices. In one of the fields where robots are used, a robot has the function of displaying the text received by e-mail or messenger in its internal display device.

In the aforementioned conventional technique, as illustrated in FIG. 1, since each robot 1 functions as a kind of a PC capable of internet, an IP address is assigned to the robot 1. When an e-mail is received to the IP address, the robot 1 stores the e-mail. When a user wants to see the received e-mail or the e-mail is set to be shown immediately as received, the robot 1 displays the received e-mail through a display device 2.

### SUMMARY OF THE INVENTION

As described, since the conventional robot only visually displays the received e-mail, it does not have the function of reading <i.e., the function of converting characters into the sounds: TTS (Text To Speech)> the received e-mail. Even though the conventional robot has the function of reading the received e-mail, since it only reads the text without any motions according to the text, its function is merely tasteless and raises no interest.

Moreover, since the e-mail system using the aforementioned robot is incapable of sharing conversation between the persons using the system, the messenger function is used to make it possible for the persons using the messenger to chat in real-time. However, in this case, the robot has only the function of displaying a text on the monitor mounted onto the robot or reading the text using the TTS engine. Therefore, there is the problem in that it is impossible to transfer the feeling of a sender to a receiver, using the robot's motions.

It is, therefore, an object of the present invention to provide a robot chatting system and method in which a robot speaks and motions, enabling the chatting including robot motion to transfer emotion. That is, in the robot chatting system and method, when two persons, who are chatting together through messenger, input the chatting text including motion by adding special characters or emoticons relating to the motions, a robot performs the motions corresponding to the special characters or emoticons while reading the general text from the chatting text including motion.

In accordance with a first aspect of the present invention, there is provided a robot chatting system including: an interface for generating a chatting text including robot motion having a text part and a motion part; a robot chatting server for providing a robot chatting service between chatting persons, using the chatting text including robot motion; a first unit for generating motion control data corresponding to the motion part of the chatting text including robot motion; a second unit for converting the text part of the chatting text including robot motion into speech data; and a robot for outputting the speech data through a speaker and simultaneously motioning based on the motion control data.

In accordance with a second aspect of the present invention, there is provided a robot chatting method including: receiving a chatting text including robot motion having a text part and a motion part, generated by chatting terminals in a robot chatting server; generating robot control data including speech data and motion control data, using the chatting text including robot motion; transmitting the robot control data to a robot operatively connected to the chatting terminals; and operating the robot to speak based on the speech data and to motion based on the motion control data.

In accordance with the present invention, when the user inputs text and its corresponding motions and sends the input text, the other user's robot reads the text and performs the relevant motions, thereby providing the robot chatting service of good quality.

### BRIEF DESCRIPTION OF THE DRAWINGS

The above and other objects and features of the present invention will become apparent from the following description of embodiments given in conjunction with the accompanying drawings, in which:

FIG. 1 is a view illustrating a conventional robot system displaying an e-mail;

FIG. 2 is a block diagram illustrating the entire constitution of a robot chatting system including motions to transfer emotion, in accordance with an embodiment of the present invention;

FIG. 3 illustrates a form of motion-related data, in accordance with the present invention;

FIG. 4 is a flow chart illustrating the operation of the robot chatting system in accordance with the present invention;

FIG. 5 illustrates a chatting screen for chatting including motion, in which an emoticon list is displayed, in accordance with the present invention;

FIG. 6 illustrates a chatting exclusive screen for chatting including motion, in which a motion name list is displayed, in accordance with the present invention;

FIG. 7 illustrates a chatting exclusive screen for chatting including motion, in which a number of sentences, their corresponding motion names, and a list thereof are displayed, in accordance with the present invention; and

FIG. 8 illustrates a tag window for the motion name, which is separately displayed from a general chatting window, in accordance with the present invention.

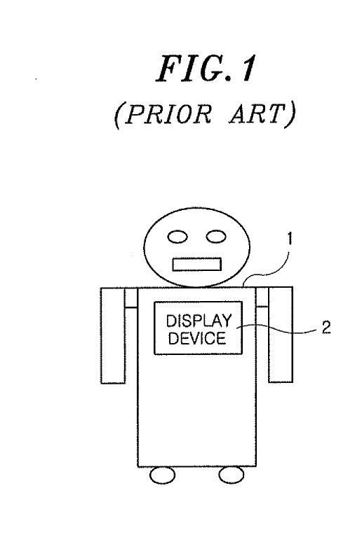

### DETAILED DESCRIPTION OF THE EMBODIMENTS

Hereinafter, embodiments of the present invention will be described in detail with reference to the accompanying drawings so that they can be readily implemented by those skilled in the art. Where the function and constitution are well-known in the relevant arts, further discussion will not be presented in the detailed description of the present invention in order not to unnecessarily make the gist of the present invention unclear.

A robot chatting system and method in which, when the user inputs text to be sent and its corresponding motions and sends the input text, the other user's robot reads the text and performs the relevant motions, will be described with reference to a embodiment of the present invention.

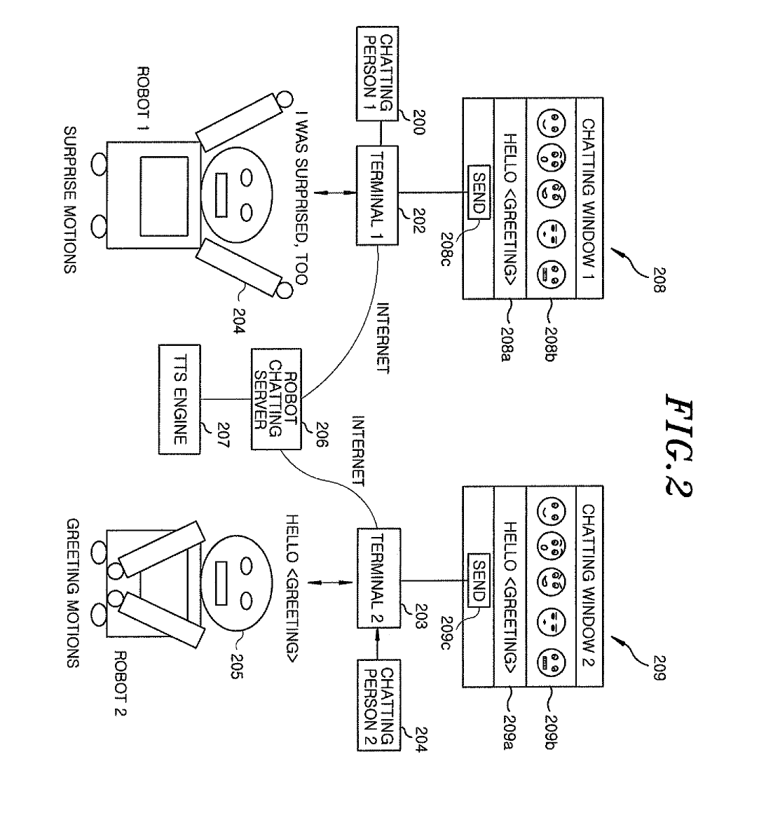

FIG. 2 is a block diagram illustrating the entire constitution of a robot chatting system including motions to transfer emotion, in accordance with an embodiment of the present invention. The robot chatting system includes: first and second terminals 202 and 203 operated by first and second chatting persons 200 and 201; first and second robots 204 and 205 connected to the first and second terminals 202 and 203 by wire or wirelessly; a robot chatting server 206 providing a robot chatting service; a TTS engine 207 operatively connected to the robot chatting server 206 and converting chatting text data received from the first and second terminals 202 and 203 into speech; and first and second chatting screens 208 and 209 each displayed in the first and second terminals 202 and 203.

The first and second chatting screens 208 and 209 each includes: as interfaces to establish text parts and motion parts, chatting windows 208a and 209a enabling input of a general text; motion list setup windows 208b and 209b enabling setup of emoticons or motions to express feelings; and SEND buttons 208c and 209c sending the input text and the information being setup in the motion list setup windows 208b and 209b.

The first and second terminals 202 and 203 are connected to the robot chatting server 206, to provide the robot chatting service to the first and second chatting persons 200 and 201 and to receive given speech data and motion control data from the robot chatting server 206. The speech data are the text data being input to the text windows 208a and 209a of the first and second terminals 202 and 203, and the motion control data are the data corresponding to emoticons designated in the emoticon/motion list setup windows 208b and 209b.

The first and second robots 204 and 205 are each connected to the first and second terminals 202 and 203 by wire or wirelessly, to receive robot control data including the speech data and the motion control data to perform speech and motions.

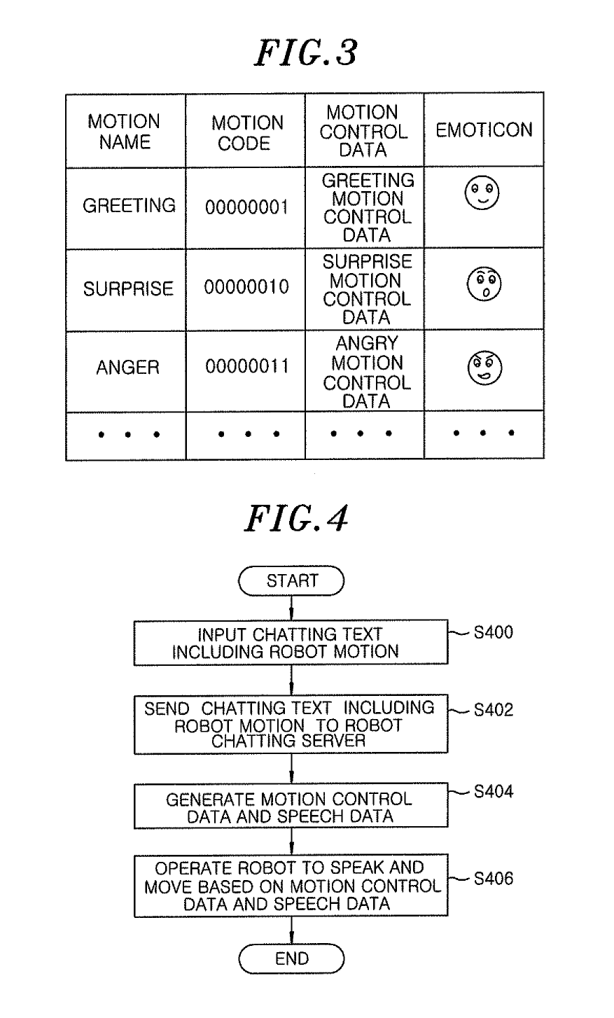

The robot chatting server 206 is connected to the first and second terminals 202 and 203 through internet, to provide the robot chatting service. Specifically, as illustrated in FIG. 3, the robot chatting server 206 stores motion names for diverse motions, motion codes, the motion control data to perform the motions corresponding to the motion codes, and emoticon image data corresponding to the motions. The robot chatting server 206 is operatively connected to the TTS engine 207 converting the text data to the speech data.

For example, for greeting motions, the robot chatting server 206 stores a motion name of ‘greeting’, a motion instruction code of ‘0000001’, a greeting motion control data of performing the greeting motions by bowing the robot's neck and clasping its hands in front and thereafter, positioning the neck to its original position and dropping the hands, and an emoticon image relating to the greeting motions.

A process of performing the chatting service between first and second chatting persons 200 and 201 using the robot chatting system having the above-described constitution will be described with reference to FIGS. 4 through 8.

With reference to FIG. 4, in step 400, the first and second chatting persons 200 and 201 input a chatting text including robot motion, by using first and second chatting screens 208 and 209 in the first and second terminals 202 and 203 as illustrated in FIG. 2. That is, the first and second chatting persons 200 and 201 each open the first and second chatting screens 208 and 209 and input the chatting text (for example, “Hello” and “I was surprised, too”, respectively) in the chatting windows 208a and 209a. Subsequently, the first and second chatting persons 200 and 201 each select the emoticons of the motions corresponding to the text from the motion list setup windows 208b and 209b at an upper part of the chatting windows 208a and 209a. Therefore, as shown in the setup windows 208a and 209a of FIG. 2, the motion name is expressed using the special characters which are not ordinarily used upon chatting, for example, <, >, &, %, @, # and the like. That is, there are displayed like “Hello <greeting>” or “I was surprised, too <surprise>”.

When the text and the motions are displayed in the chatting windows 208a and 209a, the first and second chatting persons 200 and 201 can immediately check whether the text and its corresponding motion name are properly input. When they are not properly input, the first and second chatting persons 200 and 201 may modify the text like general chatting and delete the motion part (that is, <greeting> or <surprise>) to select another emoticon.

When the text part and the motion part are completed through the above process, in step S402 the first and second chatting persons 200 and 201 select the SEND buttons 208c and 209c, so that the first and second terminals 202 and 203 send the chatting text including robot motion which has the text part and the motion part, to the robot chatting server 206. For example, when “Hello <greeting>” is indicated in the chatting window 208a of the first terminal 202 and the SEND button 208c is selected, “Hello <greeting>” is transferred to the robot chatting server 206. Then, in step S404, the robot chatting server 206 separates the text part “Hello” and the motion part “<greeting>” from each other, based on the predetermined special characters, “<” and “>”, provides the text part to the TTS engine 208 so as to be converted into the speech data and generates motion control data corresponding to the motion part. The generated motion control data and speech data are transmitted to the second terminal 203 by the robot chatting server 206. The motion control data are generated based on the data illustrated in FIG. 3. That is, the robot chatting server 206 extracts the greeting motion control data corresponding to the motion part, “<greeting>”.

The second terminal 203 transmits the motion control data and speech data to the second robot 205 connected by wire or wirelessly to the second terminal 203. Accordingly, in step S406, the second robot 205 performs the speech, “Hello”, through a speaker, based on the speech data, while performing the greeting motions corresponding to “Hello”, based on the motion control data.

When the chatting is performed between the two chatting persons in the above-described manner, the chatting is expressed by motions as well as speech, enabling the chatting text including robot motion.

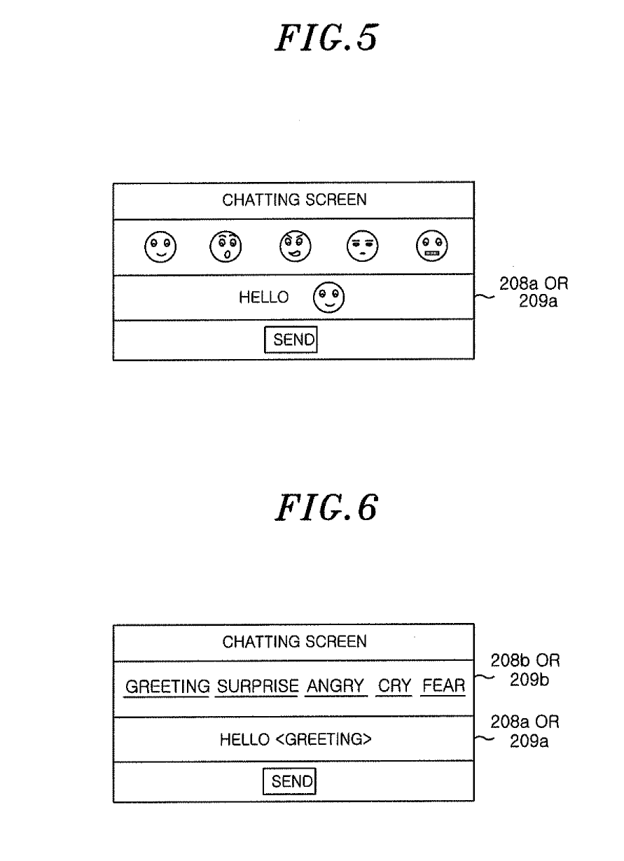

In the embodiment of the present invention, the motion parts to be indicated in the chatting windows 208a and 209a are described by putting the motion name in the special characters. However, as illustrated the chatting window 208a or 209a of FIG. 5, the motion parts may be indicated as emoticons.

When the motion parts are indicated as emoticons and the number of motions is small, the relevant motions can be more easily expressed through emoticon images. However, when the number of motions increases, it becomes difficult to easily distinguish the relevant motions through emoticons. In this case, preferably, all motions may be indicated using motion names in the motion list setup window 208b or 209b and the chatting window 208a or 209a as illustrated in FIG. 6.

Further, the motion parts of the chatting windows 208a and 209a may be indicated by directly inputting their corresponding motion code numbers, like “Hello <1>” or “Hello.124”. When the motion names are classified as a hierarchical structure in a tree form, for example, “Hello.124” is the motion instruction, wherein 1 following the period “.” instructs to express greetings, 12 instructs to express the greetings in a pleasant manner, and 124 instructs to express the greetings in the pleasant and very fast manner.

When the number of motions is considerably big and therefore it is difficult to indicate a lot of motions in the motion list setup windows 208b and 209b, a top down mode may be used. In the top down mode, when a right button of a mouse is pressed, a motion classification menu appears. When a specific motion classification is selected from the motion classification menu, a menu expressing various motions in the same classification appears to select suitable motions.

In the embodiment of the present invention, the TTS engine 207 converting text into speech and the motion-related data (motion names, motion codes, emoticons, and motion control data) are operatively connected to be stored in the robot chatting server 206. However, these may be stored in the first and second terminals 202 and 203 through the robot chatting server 206 or these may be stored in the first and second robots 204 and 205 having high performance. That is, in the first and second terminals 202 and 203 receiving the chatting text including robot motion transmitted from the robot chatting server 206, the text parts from the chatting text including robot motion is converted into the speech data by the internal TTS engine and the motion control data corresponding to the motion parts are extract, to be provided to the first and second robots 204 and 205.

Further, in the first and second robots 204 and 205 where the TTS engine 207 and the motion-related data (motion names, motion codes, emoticons, and motion control data) are loaded, it is possible to process the text parts and motion parts received through the first and second terminals 202 and 203. Furthermore, it is possible to process the chatting text including robot motion directly received through the robot chatting server 206.

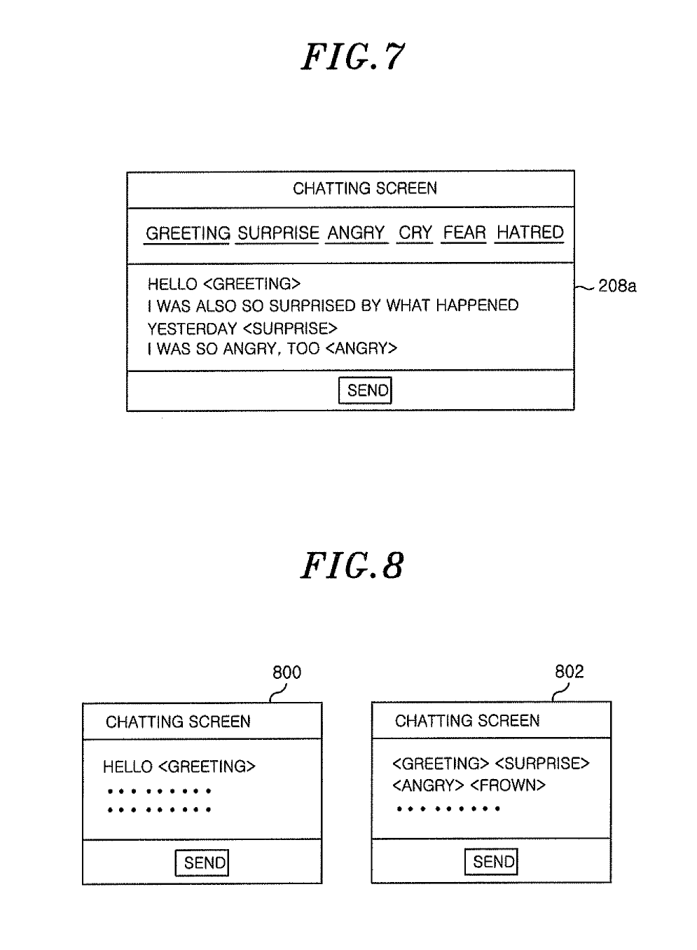

In the present invention, only when the speech data and the motion control data are simultaneously transferred to the robot, the robot is capable of performing the motions synchronizing with the speech. Specifically, as shown in FIG. 7, when the chatting text including robot motion consists of a number of the text parts and a number of the motion parts, the speech data and the motion data may be asynchronous due to a transmission delay on networks, such as internet. That is, when any one of the text data and the motion data to be synchronous with each other is slowly transmitted, a synchronization process is needed to preferably embody the present invention.

For the synchronization described above, when the robot control data are generated in the robot chatting server 206, the first and second terminals 202 and 203, or the first and second robots 204 and 205 by using the speech data and motion control data, a single file to be sent is formed by repeating a process of putting a motion code ID between the speech data and motion control data of each text (that is, speech data+motion code ID+motion control data+motion code ID+speech data+motion code ID). Then, when there is no motion control data corresponding to the speech data of the text, a special ID, for example, NULL, is used. For example, as shown in FIG. 7, when the chatting window 208a is formed of three text parts (“Hello”, “I was also so surprised by what happened yesterday” and “I was so angry”) and their corresponding motion parts (<greeting>, <surprise> and <angry>), the speech data and the motion control data which are formed in the manner of Table 1 below are transmitted to the robot. Then, the robot reproduces the speech parts and performs their corresponding motions sequentially.

TABLE 1

speech data of “Hello” + ID + greeting motion control
data + ID + speech data of “I was also so surprised by what
happened yesterday” + ID + surprise motion control data + ID +
speech data of “I was so angry” + ID + angry motion
control data + ID

As another method, a file to be sent may be formed by each sentence unit (that is, speech data+motion instruction code ID+motion control data+ID). That is, a file to be sent may be generated by inserting a motion instruction code ID between the speech data and the motion control data and inserting an ID after the speech data and the motion control data. The file formed by each sentence unit as described above is transmitted to the robot, so that the robot performs the motions while speaking by each sentence unit.

In the embodiment of the present invention, the chatting robot system including motions is realized by using the chatting screen which is an exclusive editor for the chatting including motion. However, the chatting robot system including robot motions may be realized by a general chatting editor. In this case, since the emoticons or motion names of the exclusive editor are not provided in the general chatting editor, an additional tag window 802 needs to be display on screen as illustrated in FIG. 8. The tag window 802 for providing a list of tags which can be perceived by the robot is positioned at a different position from a general chatting editor window 700. After forming a general chatting text, the chatting person may directly input a tag corresponding to a motion instruction while seeing the tag window 802 or copy the corresponding tag from the tag window 802 to be included in the general chatting text. Then, tags are properly formed by using the characters (<, >, &, # and the like) which are rarely used in the general chatting, for example, “<surprise>” or “<angry>”.

Further, in FIG. 2, the first robot 204 is connected to the first terminal 202 and the second robot 205 is connected to the second terminal 203, and the first and second terminals 202 and 203 are connected to the robot chatting server 206. However, the first and second robots 204 and 205 may be directly connected to the robot chatting server 206 through internet, to perform communication, and the first and second terminals 202 and 203 each connected to the first and second robots 204 and 205 may be used as simple input devices. In this case, the first and second terminals 202 and 203 may be personal computers, mobile phones or PDAs.

In this case, when users input the text parts and motion parts using their own terminals, for example, personal computers, mobile phones or PDAs, and send the text parts and motion parts to the first and second robots 204 and 205 by wire or wirelessly, for example, infrared communication, bluetooth and the like, the first and second robots 204 and 205 send the text parts and motion parts to the robot chatting server 206 through internet. Then, the text parts are converted into the speech data by the TTS engine 207 operatively connected to the robot chatting server 206. The motion control data related to the motion parts are extracted by the robot chatting server 207. The speech data and the motion control data are received by the first and second robots 204 and 205. Then, the first and second robots 204 and 205 perform the speech and motions.

Further, the first and second robots 204 and 205 and the first and second terminals 202 and 203 may be all connected to the robot chatting server 206. The first and second terminals 202 and 203 connected to the robot chatting server 206 perform the function of membership registration and log-in for the robot chatting service and the function of designating a robot of the other chatting person. The robot chatting server 206 may perform the function of sending the speech data and the motion control data to the first and second robots 204 and 205.

In this case, the text parts and motion parts formed by the first and second terminals 202 and 203 are transferred to the robot chatting server 206, and the robot chatting server 206 sends the speech data and the motion control data to the designated robot of the other chatting person. Then, the robot of the other chatting person performs the speech and motions corresponding to the speech data and the motion control data.

In the present invention, only the chatting between two chatting persons is described. However, the principles of the present invention are applicable to the chatting among multiple chatting persons being three or more.

For example, when chatting persons are A, B and C and the chatting persons respectively has two robots a1, a2, b1, b2, c1 and c2, the robot chatting system may be constituted in the manner that the speech data and motion control data corresponding to the chatting text including robot motion which are sent by the chatting persons A and B are respectively reproduced in the robots a1 and a2 connected to the terminal of the chatting person A, the speech data and motion control data corresponding to the chatting text including robot motion which are sent by the chatting persons A and C are respectively reproduced in the robots b1 and b2 connected to the terminal of the chatting person B, and the speech data and motion control data corresponding to the chatting text including robot motion which are sent by the chatting persons A and B are respectively reproduced in the robots c1 and c2 connected to the terminal of the chatting person C.

Further, in the embodiment of the present invention, the emoticons in the form of images are used. However, the character emoticons, such as “̂̂”, may be used.

Further, in the embodiment of the present invention, the SEND button is selected to send the text parts and the motion parts. However, like general chatting, a specific key, for example, an enter key, may be operated to send the text parts and the motion parts.

In accordance with the preferred embodiment of the present invention, when the user inputs text to be sent and its corresponding motions and sends the input text, the user's robot reads the text and performs the relevant motions, enabling the robot chatting system including robot motions to transfer feelings.

While the invention has been shown and described with respect to the embodiments, it will be understood by those skilled in the art that various changes and modifications may be made without departing from the scope of the invention as defined in the following claims.

What is claimed is:

1. A robot chatting system comprising:
an interface for generating a chatting text including robot motion having a text part and a motion part;
a robot chatting server for providing a robot chatting service between chatting persons, using the chatting text including robot motion;
a first unit for generating motion control data corresponding to the motion part of the chatting text including robot motion;
a second unit for converting the text part of the chatting text including robot motion into speech data; and
a robot for outputting the speech data through a speaker and simultaneously motioning based on the motion control data.

2. The robot chatting system of claim 1, wherein the first unit is built in the robot chatting server.

3. The robot chatting system of claim 1, wherein the first unit and the second unit are built in the robot chatting server.

4. The robot chatting system of claim 1, wherein the first unit is built in the robot.

5. The robot chatting system of claim 1, wherein the first unit and the second unit are built in the robot.

6. The robot chatting system of claim 1, wherein the first unit is built in a separate terminal connected to the robot by wire or wirelessly.

7. The robot chatting system of claim 1, wherein the first unit and the second unit are built in a separate terminal connected to the robot by wire or wirelessly.

8. The robot chatting system of claim 1, wherein the interface provides a menu in a top down mode to designate the motion part.

9. The robot chatting system of claim 1, wherein the motion part is expressed by using an emoticon, a special character which is distinguished from the text part, or a predefined code.

10. The robot chatting system of claim 1, wherein, when the number of the text part is two or more and the number of the motion part is two or more, the robot chatting server uses an ID between the motion control data corresponding to the motion part and the speech data corresponding to the text part, to be provided to the robot.

11. A robot chatting method comprising:
receiving a chatting text including robot motion having a text part and a motion part, generated by chatting terminals in a robot chatting server;
generating robot control data including speech data and motion control data, using the chatting text including robot motion;
transmitting the robot control data to a robot operatively connected to the chatting terminals; and
operating the robot to speak based on the speech data and to motion based on the motion control data.

12. The robot chatting method of claim 11, further comprising:
providing the chatting text including robot motion to the chatting terminal; and
after generating the robot control data using the chatting text including robot motion in the chatting terminal, providing the robot control data to the robot.

13. The robot chatting method of claim 11, further comprising:
providing the chatting text including robot motion to a robot connected to at least one receiver chatting terminal; and
after generating the robot control data using the chatting text including robot motion in the robot, controlling the robot to speak and motion based on the robot control data.

14. The robot chatting method of claim 11, wherein, when the number of the text part is two or more and the number of the motion part is two or more, the generating of the robot control data comprises using an ID between the motion control data corresponding to the motion part and the speech data corresponding to the text part, to be provided to the robot.
